(19) United States
(12) Patent Application Publication
(10) Pub. No.: US 2010/0290522 A1
(43) Pub. Date: Nov. 18, 2010

(54) IMAGE TRANSMISSION METHOD AND IMAGE TRANSMITTER

(75) Inventor: Yoshiyuki Otani, Gifu (JP)

Correspondence Address: MCDERMOTT WILL & EMERY LLP, 600 13TH STREET, N.W., WASHINGTON, DC, 20005-3096, US

(73) Assignee: SANYO ELECTRIC CO., LTD., Moriguchi-shi, Osaka (JP)

(21) Appl. No.: 12/742,887

(22) PCT Filed: Nov. 13, 2008
(86) PCT No.: PCT/JP2008/003305

§ 371 Date: May 13, 2010

(30) Foreign Application Priority Data
Nov. 15, 2007 (JP) 2007-297332
Oct. 31, 2008 (JP) 2008-280838

(51) Int. Cl. H04B 1/66

(52) U.S. Cl. 375/240.02; 375/E07.154

(57) ABSTRACT

The control unit verifies whether or not the coded data of one frame has been transmitted within each frame period. When it hasn't, the control unit increases the compression ratio of a compression unit. When the coded data of one frame has been transmitted, the control unit compares the amount of coded data against a first and a second threshold value. When the amount of coded data is greater than or equal o the first threshold value, the control unit increases the compression ratio of the compression unit. When it is less than or equal to the second thresh hold, the control unit lowers the compression ratio of the compression unit.

### TECHNICAL FIELD

The present invention relates to a communication technique for transmitting image signals, and it particularly relates to a method for transmitting image signals using a radio communication and an image transmitting method and an image transmitting apparatus using said method.

### BACKGROUND TECHNOLOGY

In recent years, with the advanced radio communication technology such as mobile phones and LANs (Local Area Network), the large volumes of data can be transmitted via a radio communication network as well. Thus it is demanded that the high-quality moving images be transmitted over the radio communication network as well.

To realize such a method for transmitting the moving images, known is a technique where the motion JPEG (Joint Photographic Experts Group) scheme is employed as a method for compressing the moving images and the moving image data thus compressed and coded by the motion JPEG scheme are transmitted over a mobile phone network (See Patent Document 1, for instance).

[Patent Document 1] Japanese Patent Publication No. Hei10-285565.

### DISCLOSURE OF THE INVENTION

### Problems to be Solved by the Invention

In the conventional techniques, the moving images are transmitted after the compression ratio is adjusted so that the amount of coded data per frame can be uniform. However, since the radio communication network is sensitive to the propagation environment, there are cases where sufficient transmission rates cannot be assured. In such a case, the transmission of moving images sometimes cannot be completed within a predetermined time.

The present invention has been made in view of such circumstances and a purpose thereof is to provide an image transmitting apparatus capable of transmitting moving images requiring high real-timeliness.

### Means for Solving the Problems

In order to resolve the above problems, an image transmitting apparatus according to one embodiment of the present invention comprises: a compressing-coding unit configured to generate coded data by compressing and coding moving image data; a transmitter configured to transmit the coded data generated by the compressing-coding unit; an acquiring unit configured to acquire the moving speed of an object; a control unit configured to set the compression ratio with which to compress and code the moving image data in the compressing-coding unit, based on the moving speed acquired by the acquiring unit, a transmission status of the coded data in the transmitter and a data amount of the coded data generated by the compressing-coding unit.

Another embodiment of the present invention relates to an image transmitting method. This method comprises: generating coded data by compressing and coding moving image data; transmitting the generated coded data; acquiring the moving speed of an object; and setting the compression ratio with which to compress and code the moving image data, based on the moving speed, a transmission status of coded data and a data amount of the generated coded data.

### Effect of the Invention

The present invention verifies whether the coded frame has been transmitted within a frame period or not, so as to set the compression ratio used in the compressing and coding. Thus, the amount of data to be transmitted can be adjusted according to a propagation environment and therefore the transmission of the moving images with high real-timeliness can be achieved.

### BRIEF DESCRIPTION OF THE DRAWINGS

FIG. 1 is a conceptual diagram showing a structure of an image transmitting apparatus according to a first embodiment of the present invention.

FIG. 2 is a flowchart showing a procedure for changing the compression ratio in the image transmitting apparatus shown in FIG. 1.

FIG. 3 illustrates a structure of an image communication system according to a second embodiment of the present invention.

FIG. 4 illustrates a structure of an image transmitting apparatus shown in FIG. 3.

FIG. 5 illustrates a structure of a storage shown in FIG. 4.

FIG. 6 illustrates a data structure of a table shown in FIG. 5.

FIG. 7 illustrates a structure of an image receiving apparatus shown in FIG. 3.

FIG. 8 is a flowchart showing a procedure for changing the compression ratio in an image transmitting apparatus shown in FIG. 3.

FIG. 9 illustrates a structure of a control unit according to a third embodiment of the present invention.

### DESCRIPTION OF THE REFERENCE NUMERALS

100 Transmitter

101 Compression unit

102 Recording unit

103 Control unit

200 Image communication system

202 Image transmitting apparatus

204 Image receiving apparatus

206 Speed sensor

208 Vehicle

220 Image pickup unit

222 Compressing-coding unit

224 Packetization processing unit

226 Communication unit

228 Control unit

230 Acquiring unit

232 Storage

234 Selector

236 Calculation unit

238 Decision unit

### BEST MODE FOR CARRYING OUT THE INVENTION

### First Embodiment

An outline of the present invention will be given before a specific description thereof. A first embodiment of the present invention relates to an image transmitting apparatus for transmitting moving images via a radio communication network (wireless LAN such as IEEE 802.11n).

As data are transmitted via the radio communication network, the transmission rate varies depending on a propagation environment and therefore there are cases where the transmission of a predetermined data amount cannot be completed within a predetermined time period.

Thus, in the image transmitting apparatus according to an embodiment of the present invention, it is verified whether the data equivalent to one frame has been transmitted within a frame period or not. And if the transmission of the data is not completed within the frame period, the setting will be made so that the compression ratio is increased. As a result, the compressing/coding processing of compressing and coding the moving images with the compression ratio suitable for the propagation environment can be performed and the transmission of moving images with high real-timeliness can be assured.

Here, each “frame” is a single screen unit constituting the moving image data. In the motion JPEG compression scheme, the intra-frame compression processing is performed in units of screen. In the moving image data of interlace scheme such as NTSC (National Television Standards Committee), the “frame” corresponds to “field”. Also, in the moving image data of non-interlace scheme such as VGA (Video Graphics Array), the “frame” also correspond to “frame”.

The “frame period” is a time interval between frames assigned on the time axis. It is about 16.6 ms in the aforementioned case of NTSC, and it is about 33.3 ms in the case of VGA.

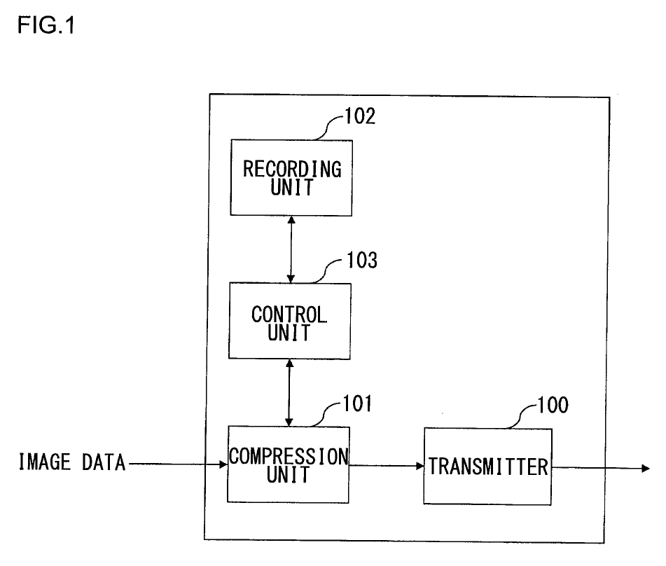

FIG. 1 is a conceptual diagram showing a structure of an image transmitting apparatus according to the first embodiment of the present invention. The image transmitting apparatus includes a transmitter 100, a compression unit 101, a recording unit 102, and a control unit 103.

In FIG. 1, the transmitter 100, which is connected to a not-shown radio communication network, converts data to be transmitted, into a data format suitable for the radio communication network and outputs it to the radio communication network. The transmitter 100 includes a transmit buffer for buffering the outputs received from the compression unit 101.

If the coded data outputted from the compression unit 101 reaches a predetermined transmission unit (e.g., 1500 bytes), the transmitter 100 will read out coded data from the transmit buffer, convert the data format thereof and transmit the coded data to the radio communication network.

The compression unit 101 performs compressing/coding processing on the moving image data inputted from an external source, using a motion JPEG compression scheme. The motion JPEG compression scheme is a method where the JPEG compression method for compressing still images is applied to the moving images, and the motion JPEG compression scheme performs JPEG compression processing in units of frame of moving image data.

The compression unit 101 performs processings such as discrete cosine transform (DCT), quantization and Huffman coding. Then the compression unit 101 appends header information to the moving image data that has been subjected to the compression processing, so as to generate coded data in compliance with the motion JPEG compression scheme. Here, the header information contains identification information indicating the compression ratio, whether a sequential method or progressive method is in use, and the like. Then, every time coded data equivalent to a predetermined output unit is generated, it is outputted to the transmitter 100. Here the predetermined output unit may be, for example, a macroblock unit or payload length unit of radio packet.

The compression unit 101 changes the compression ratio in the compression processing according an active parameter contained in a config file discussed later. For example, changing the quantization step changes the compression ratio.

The recording unit 102 records the config file that contains the active parameters, used to change the compression ratio of the compressing unit 101, and the like. It is preferable that a plurality of config files be prepared in order that a wide range of compression ratios can be set ranging from a low compression ratio setting (i.e., high-quality compression) to a high compression ratio setting (i.e., low-quality compression).

The control unit 103 controls the timing of the image transmitting apparatus as a whole, and the like. Also, the control unit 103 initializes the start timing of moving image data; for example, a timing counter is initialized by a rising edge of a vertical synchronizing signal (Vsync: 1195125407546_{—}0) of the moving image data. As it is let known that one frame period has elapsed after the frame start timing of the moving image data, namely, that the frame end timing has been reached, the control unit 103 verifies the remaining amount of coded data in the transmit buffer.

If a sufficient transmission rate is not assured, there will be cases where a frame to be processed undergoes the compressing/coding processing but the transmission of the coded data of compressed and coded frame cannot be completed within one frame period from the frame start timing of moving data.

If the status where the transmission of the coded data of frame to be processed cannot be completed within one frame period continues, an overflow will occur in the transmit buffer and the moving image data cannot be transmitted in real time.

Thus, the control unit 103 determines, based on the remaining amount of coded data in the transmit buffer, whether or not the transmission of coded data of frame to be processed, which is inputted from a not-shown image transmitting apparatus (e.g., camera) has been completed within one frame period starting from the frame start timing of moving image data.

If the remaining amount of coded data is verified (namely, if the transmission of coded data equivalent to one frame cannot be completed within the frame period), it will be determined that the compression ratio in the compression unit 101 is too low relative to the transmission rate and therefore the control unit 103 will increase the compression ratio of the compressing unit 101. Thus, the control unit 103 reads out a config file with which to set the compression ratio to a value higher than the current compression ratio, from the recording unit 102 and sets the compression ratio of the compressing unit 101 to a higher value, based on a set parameter contained in this config file. When the compression ratio is to be set to a higher value, it may be set to a compression ratio that is higher, by one step, than the current compression ratio, or may be set to the maximum compression ratio. If it is set to the compression ratio that is higher by one step, the transmission of moving image data suitable for a propagation environment can be achieved while suppressing the degradation in the quality of coded data. If it is set to the maximum compression ratio, the frequent changes of compression ratio is suppressed and therefore the moving image data can be robustly transmitted.

When the coded data are generated by compression unit 101, the amount of coded data is preferably larger if high-quality moving image data are to be transmitted. However, if the amount of coded data is excessively large, the sufficient transmission rate cannot be assured depending on a propagation environment and therefore the compression ratio will be changed frequently, thereby making it difficult to robustly transmit the moving image data.

To robustly transmit the high-quality moving image data, therefore, control unit 103 sets the compression ratio so that the amount of coded data can be fit into a predetermined range when the remaining amount of coded data is not verified (namely, when the transmission of coded data equivalent to one frame is completed within the frame period).

The control unit 103 stores a threshold value related to an upper limit of the amount of coded data (hereinafter referred to as “first threshold value”) and a threshold value related to a lower limit of the amount of coded data (hereinafter referred to as “second threshold value”). Here, the first threshold value is larger than the second threshold value; for example, the second threshold value is 40K bytes if the first threshold value is 48K bytes. These threshold values are obtained through experiments (for example, the compression ratio is varied for various kinds of moving image data, and the image qualities of the thus generated coded data undergo subjective evaluations, and so forth). Further, these threshold values may be such that a different set of threshold values are prepared for each of different schemes of moving image data (for example, the above-described NTSC and VGA).

When storing the coded data for one frame generated by the compression unit 101 in the transmit buffer of the transmitter 100, the control unit 103 measures the amount of said data.

When the transmission of the coded data equivalent to one frame has been completed within a frame period, the control unit 103 compares the measured data amount against the first threshold value. If the measured data amount is larger than the first threshold value, the control unit 103 will determine that the current compression ratio is too low, and raise the compression ratio set in the compression unit 101. The setting for raising the compression ratio of the compression unit 101 is done in a similar manner analogous to the setting done in the case where the transmission of coded data for one frame is not completed within the frame period.

Also, when the transmission of coded data for one frame has been completed within the frame period, the control unit 103 compares the measured data amount against the second threshold value. If the measured data amount is smaller than the second threshold value, the control unit 103 will determine that the current compression ratio is too high, and lower the compression ratio set in the compression unit 101. As a result, the control unit 103 reads out a config file, by which a compression ratio lower than the current compression ratio is set, from the recording unit 102 and sets the compression ratio of the compression unit 101 to a lower ratio, based on the set parameter contained in this config file. When the compression ratio is to be set to a lower ratio, it may be set to a compression ratio that is lower, by one step, than the current compression ratio or set to a minimum compression ratio. When it is set to the compression ratio lower by one step, the transmission of moving image data suitable for a propagation environment can be achieved while the degradation in the quality of coded data is being suppressed. When it is set to the minimum compression ratio, the high-quality moving image data can be transmitted.

Note that the compression ratio may be changed with the timing at which the compression unit 101 generates coded frame equivalent to one frame, namely in a frame cycle. Or the compression ratio may be changed with the timing at which the control unit 103 determines that the transmission of the coded data for one frame cannot be completed within the frame period. Changing the compression ratio in a frame cycle reduces the load on the compressing/coding processing. Changing the compression ratio with the timing at which the control unit 103 determines that the transmission thereof cannot be completed within the frame period improves the following capability.

This structure may be implemented hardwarewise by elements such as a CPU, memory and other LSIs of an arbitrary computer, and softwarewise by memory-loaded programs or the like. Depicted herein are functional blocks implemented by cooperation of hardware and software. Therefore, it will be obvious to those skilled in the art that the functional blocks may be implemented by a variety of manners including hardware only, software only or a combination of both.

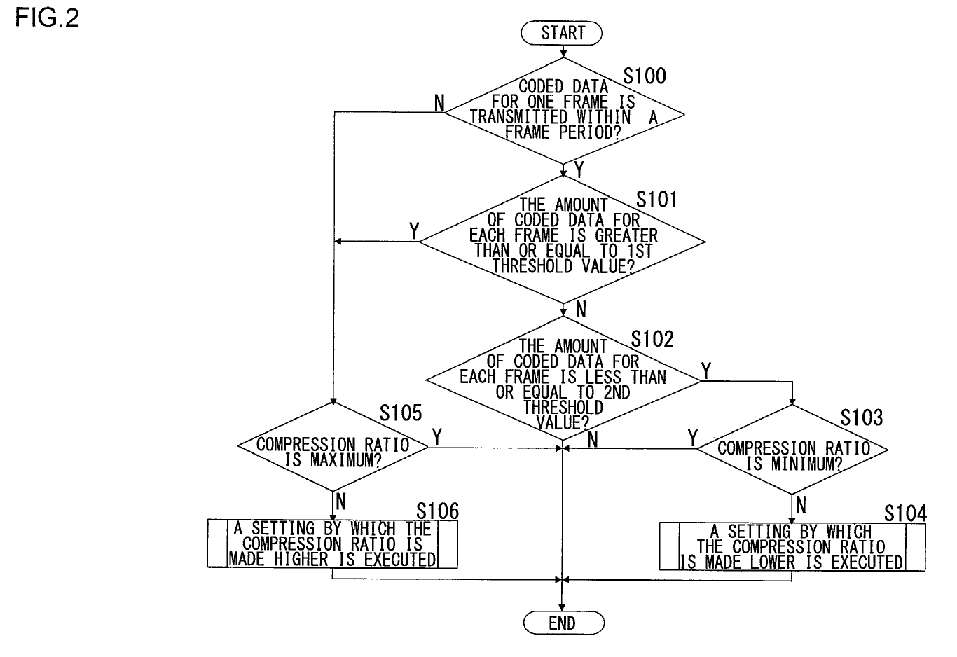

FIG. 2 is a flowchart showing a procedure for changing the compression ratio. The control unit 103 detects the remaining amount of coded data in the transmit buffer of the transmitter 100 and verifies whether the transmission of the coded data equivalent to one frame has been completed within the frame period or not (S100). If transmission of the coded data for one frame has been completed within the frame period (Y of S100), the control unit 103 will verify the amount of coded data for one frame is greater than or equal to the first threshold value or not (S101). If the amount of coded frame for one frame is less than the first threshold value (N of S101), the control unit 103 will verify whether the amount of coded data for one frame is less than or equal to the second threshold value or not (S102). If the amount of coded data for one frame is less than the second threshold value (Y of S102), the control unit 103 will verify whether the compression ratio of the compression unit 101 is the minimum compression ratio or not (S103). If the compression ratio is not the minimum (N of S103), the control unit 103 will read out the corresponding config file from the recording unit 102, set the compression ratio of the compression unit 101 based on the config file and then terminate the processing (S104).

If the transmission of the coded data equivalent to one frame is not completed within the frame period (N of S100) or the amount of coded data for one frame is less than the first threshold value (Y of S101), the control unit 103 will verify whether the compression ratio of the compression unit 101 is the maximum compression ratio or not (S105). If the compression ratio is not the maximum (N of S105), the control unit 103 will read out the corresponding config file from the recording unit 102, raise the compression ratio of the compression unit 101 based on the config file and then terminate the processing (S106). If the amount of coded data for one frame is not less than or equal to the second threshold value (N of S102) or the compression ratio is the minimum (Y of S103) or the compression ratio is the maximum (Y of S105), the processing will be terminated.

By employing the embodiment of the present invention as described above, the operation performed and the effects achieved thereby are as follows.

If the amount of coded data is greater than or equal to the first threshold value, the setting is made so that the compression ratio of the compression unit 101 is increased. If the amount of coded data is less than or equal to the second threshold value, the setting is made so that the compression ratio of the compression unit 101 is decreased. Accordingly, the compression/coding processing of moving images can be performed with the compression ratio suitable for the propagation environment, so that the moving images can be robustly transmitted in real time and with high quality.

### Second Embodiment

Similar to the first embodiment, a second embodiment of the present invention relates to an image communication system for transmitting the moving images via a radio communication network. In the second embodiment, it is assumed that an image communication system, which is comprised namely of an image transmitting apparatus and an image receiving apparatus, is installed in a moving vehicle such as an automobile. For example, the image transmitting apparatus transmits the moving images picked up by an in-vehicle camera, and the image receiving apparatus displays the moving images received on a monitor. Similar to the first embodiment, the image transmitting apparatus changes the compression ratio for the moving images in accordance with the remaining amount of coded data in the transmit buffer. Note here that the remaining amount thereof in the transmit buffer varies depending on the throughput of the communication network and, in general, the throughput of the radio communication network also depends on whether other radio apparatuses located in the vicinity have the same radiofrequency or not. Where the same radiofrequency is being used, the image transmitting apparatus interrupts the transmission by a carrier sense and therefore the throughput drops. Even if a transmission is partially ongoing, the collision of signals causes the throughput to drop. On the other hand, where the image transmitting apparatus is installed in the vehicle, the radio apparatuses located nearby change as the vehicle moves.

Under such circumstances, the image transmitting apparatus according to the present embodiment stores a plurality of kinds of threshold values according to the moving speed of the vehicle, and selects one kind of threshold value based on the moving speed thereof. Similar to the first embodiment, the image transmitting apparatus changes the compression ratio, based on the remaining amount and the threshold value. In other words, a criterion for changing the compression ratio is varied according to the moving speed. More specifically, even though interference occurs with predetermined timing between the image transmitting apparatus and the surrounding radio apparatuses, the interference is reduced as the image transmitting apparatus installed in the vehicle moves. A period of time that elapses before the interference is reduced becomes shorter as the moving speed increases. Accordingly, the image transmitting apparatus performs a control such that the compression ratio is less likely to be changed as the moving speed increases.

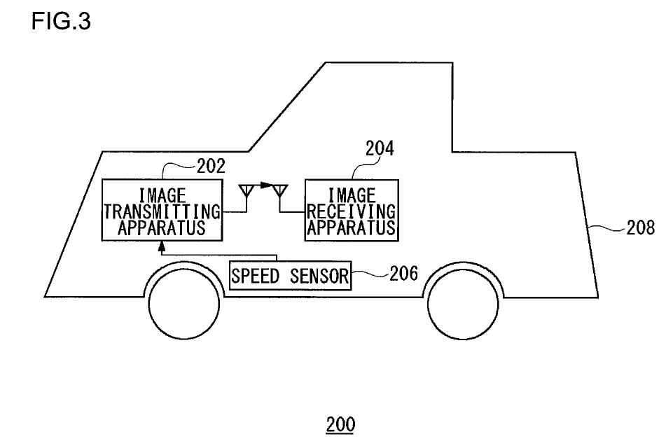

FIG. 3 illustrates a structure of an image communication system 200 according to the second embodiment of the present invention. The image communication system 200, which includes an image transmitting apparatus 202, an image receiving apparatus 204, and a speed sensor 206, is installed in a vehicle 208. The speed sensor 206 measures the moving speed of the vehicle 208. A known technique may be used as the speed sensor 206 and therefore the description thereof is omitted here. The speed sensor 206 outputs the measured moving speed to the image transmitting apparatus 202. The image transmitting apparatus 202 is placed in the vehicle so that the images of a front view, side view and rear view as seen from the vehicle 208 are picked up. For clarity of explanation, it is assumed herein that the image transmitting apparatus 202 is installed in a front part of the vehicle 208 and picks up the images of a front view as seen from the vehicle 208.

The image transmitting apparatus 202 compresses and codes the picked-up moving image data so as to generate coded data. Here, the image transmitting apparatus 202 controls the compression ratio used in the compressing and coding of data, based on the moving speed measured by the speed sensor 206. A detailed description thereof will be given later. Also, the image transmitting apparatus 202 transmits the coded data to the image receiving apparatus 204. The image receiving apparatus 204 receives the coded data sent from the image transmitting apparatus 202. The image receiving apparatus 204 reproduces the moving image data by decoding the coded data, and displays the reproduced moving image data.

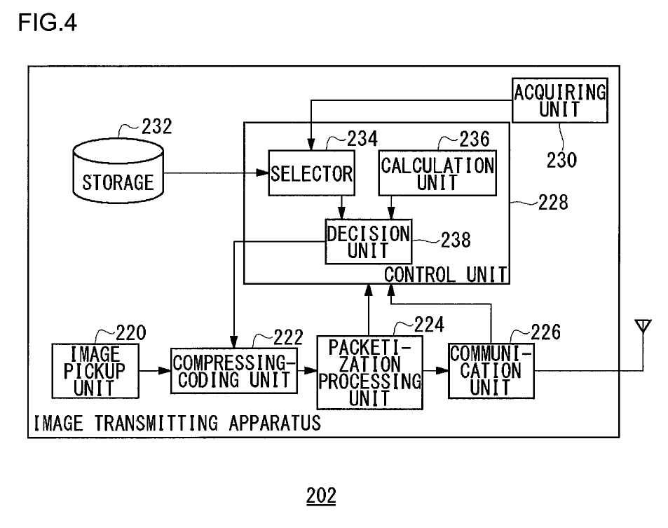

FIG. 4 illustrates a structure of the image transmitting apparatus 202. The image transmitting apparatus 202 includes an image pickup unit 220, a compressing-coding unit 222, a packetization processing unit 224, a communication unit 226, an control unit 228, an acquiring unit 230, and storage 232. The control unit 228 includes a selector 234, a calculation unit 236, and a decision unit 238.

The image pickup unit 220 generates moving image data. A structure of the image pickup unit 220 may be that employed in a known technology and therefore the description thereof is omitted here. The image pickup unit 220 outputs the moving image data to the compressing-coding unit 222. The compressing-coding unit 222 is equivalent to the above-described compression unit 101. The compressing-coding unit 222 receives the input of the moving image data from the image pickup unit 220. As described above, the compressing-coding unit 222 generates code data by compressing and coding the moving image data. The compression ratio used in the compressing and coding of data is set by the decision unit 238 described later. Here, the compression ratios are discretely set in five steps including a first compression ratio through a fifth compression ratio. In these five steps, the first compression ratio is a high compression ratio, and the fifth compression ratio is a low compression ratio. The compressing-coding unit 222 outputs the coded data to the packetization processing unit 224.

The packetization processing unit 224 includes the transmit buffer which is included in the above-described transmitter 100. The packetization processing unit 224 receives the input of the coded data from the compressing-coding unit 222. The packetization unit 224 stores the coded data therein and then fragments the coded data so as to generate a packet signal. The packetization processing unit 224 outputs the packet signal to the communication unit 226. Also, the packetization unit 224 outputs the data amount of the inputted coded data to the control unit 228 as appropriate. For example, the packetization processing unit 224 outputs the data amount in units of frame. As a result, the following processing will be performed in units of frame as well.

The communication unit 226 is equivalent to the above-described transmitter 100. The communication unit 226 transmits the packet signal generated by the compressing-coding unit 222. The communication unit 226 transmits the packet signal via an antenna. The communication unit 226 measures the transmission rate and outputs the thus measured transmission rate to the control unit 228 as appropriate.

The calculation unit 236 receives the input of the transmission rate from the communication unit 226. That is, the calculation unit 236 determines the transmission status of the coded data in the transmitter 100. Also, the calculation unit 236 receives the input of the data amount of coded data from the compressing-coding unit 222. The calculation unit 236 calculates the remaining amount of coded data, based on the transmission rate and the data amount. More specifically, the calculation unit 236 multiplies the transmission rate by a predetermined period of time so as to derive the data amount transmitted over the predetermined period of time. Also, the calculation unit 236 subtracts the derived data amount from the data amount of coded data so as to calculate the remaining amount of coded data. Also, the calculation unit 236 outputs the remaining amount of coded data to the decision unit 238.

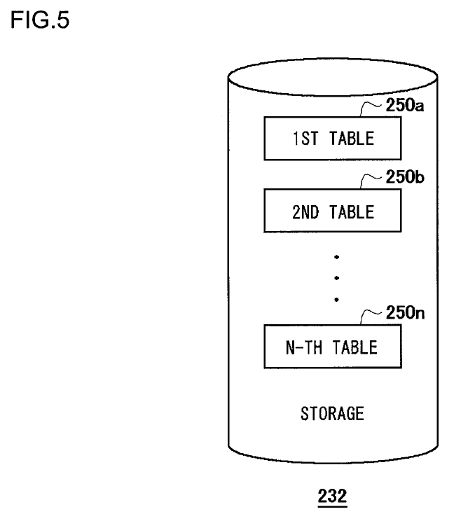

The acquiring unit 230 acquires the moving speed of the vehicle 208 from the not-shown speed sensor 206. The acquiring unit 230 outputs the moving speed to the selector 234. The storage 232 stores beforehand a threshold value for the remaining amount calculated by the calculation unit 236. Here, the storage 232 brings a plurality of threshold values into a table as one combination and stores a plurality of such tables. Also, each table is so defined as to be associated with a moving speed. FIG. 5 illustrates a structure of the storage 232. As shown in FIG. 5, the storage 232 stores a first table 250a, a second table 250b, . . . , and an Nth table 250n, which are generically referred to as “table 250” or “tables 250”. A threshold value stored in each table is so defined as to specify the compression ratio for the remaining amount.

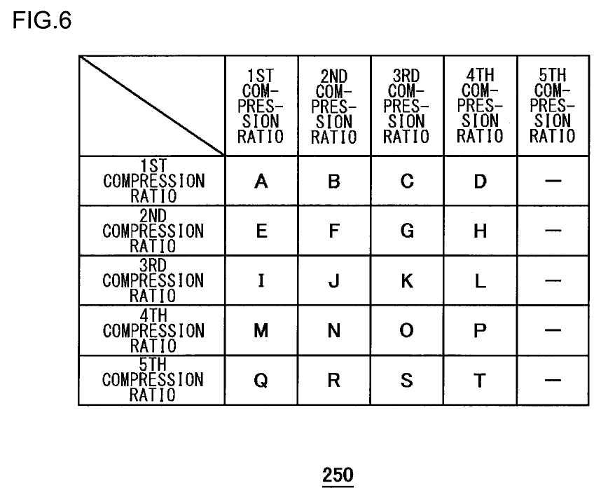

FIG. 6 illustrates a data structure of the table 250. Each of the plurality of tables 250 is specified as shown in FIG. 6. As described above, the first to fifth compression ratios are specified here. On the left-side column of FIG. 6, the first to fifth compression ratios in current use are indicated in the vertical direction. On the top row of FIG. 6, the first to fifth compression ratios to which those in current use are to be changed are indicated in the horizontal direction. Also, a plurality of threshold values that relate the compression ratios in current use to a “change to which compression ratio” are indicated as “A” to “T”. As described above, each threshold value is a value compared with the remaining amount of coded data. A description of each threshold will be given later. Now refer back to FIG. 4.

The selector 234 acquires the moving speed from the acquiring unit 230. The selector 234 selects any one of the plurality of tables 250 stored in the storage 232, based on the moving speed. More specifically, as described above, each table 250 is so defined as to be associated with the moving speed, and the selector 234 selects a table 250 associated with the moving speed closest to the acquired moving speed. The selector 234 outputs the thus selected table 250 to the decision unit 238.

The decision unit 238 receives the table 250 from the selector 234, and also receives the remaining amount of coded data from the calculation unit 236. The decision unit 238 determines the compression ratio in the compressing-coding unit 222, based on the table 250 and the remaining amount thereof. More specifically, the decision unit 238 specifies the compression ratio that is currently used in the compressing-coding unit 222, and extracts, from the table 250, a threshold value associated with the specified compression ratio. A description is now given in conjunction with FIG. 6. Suppose, for example, that the compression ratio in current use is the “third compression ratio”. Then the decision unit 238 extracts the threshold values “I”, “J”, “K”, and “L”, which are contained in the row corresponding to the third compression ratio. The decision unit 238 compares each threshold value thus extracted with the remaining amount thereof so as to specify a threshold value that is larger than the remaining amount.

As described above, since the first compression ratio is the maximum compression ratio, the use of the first compression ratio is more suitable as the remaining amount is larger. On the other hand, since the fifth compression ratio is the minimum compression ratio, the use of the fifth compression ratio is more suitable as the remaining amount is smaller. Accordingly, the threshold for the first compression ratio becomes larger than that for the fourth compression ratio. In other words, the size of each threshold is related such that “(the threshold value for first compression ratio)>(the threshold value for second compression ratio)>(the threshold value for third compression ratio)>(the threshold value for fourth compression ratio)”; in the above-described example, the relation of “I>J>K>L” holds. As a result, if a threshold for which the remaining amount is larger than the threshold value is to be specified, a plurality of threshold values may be specified. In that case, the decision unit 238 may specify the largest threshold value. Note that the decision unit 238 may not be able to specify any threshold value.

The decision unit determines a change to a compression ratio associated with the specified threshold value. For example, if the specified threshold value is the “threshold value for the second compression ratio”, the decision unit 238 will determine a change to the second compression ratio. If the compression ratio is not specified, the decision unit 238 will determine a change to the fifth compression ratio, that is, the lowest compression ratio. If the compression ratio to which the compression in current use is to be changed is the same as the compression ratio in current use, the decision unit 238 will determine to keep the compression ratio in current use. Though the plurality of tables 250 are provided according to the moving speed, as described above, the threshold values differ in each table 250. The threshold values that are associated mutually in the plurality of tables 250 become smaller for the table 250 where the moving speed is high. That is, as the moving speed becomes higher, the compression ratio is likely to be fixed at a higher value. This may mean that as the moving speed becomes higher, the compression ratio is less likely to be changed. Or it may be said that the higher the moving speed, the higher the compression ratio will be. By performing the above-described processing, the decision unit 238 sets the compression ratio with which to compress and code the data in the compressing-coding unit 222.

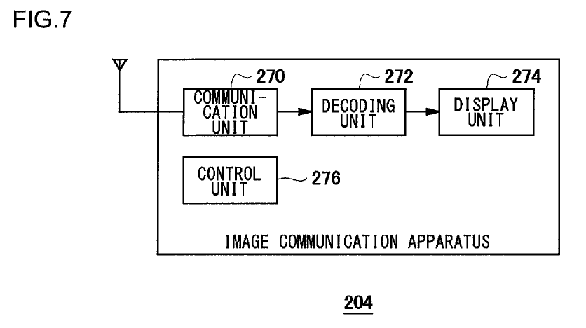

FIG. 7 illustrates a structure of the image receiving apparatus 204. The image receiving apparatus 204 includes a communication unit 270, a decoding unit 272, a display unit 274, and a control unit 276. The communication unit 270 receives the packet signal sent from the not-shown image transmitting apparatus 202 via an antenna. The communication unit 270 extracts coded data from the packet signal. Also, the communication unit 270 outputs the coded data to the decoding unit 272. The decoding unit 272 receives the coded data fed from the communication unit 270. The decoding unit 272 decodes the coded data so as to reproduce the moving image data. A known technique may be used for the decoding and therefore the description thereof is omitted here. The decoding unit 272 outputs the moving image data to the display unit 274. The display unit 274 receives the moving image data from the decoding unit 272, and displays the moving image data on a not-shown monitor.

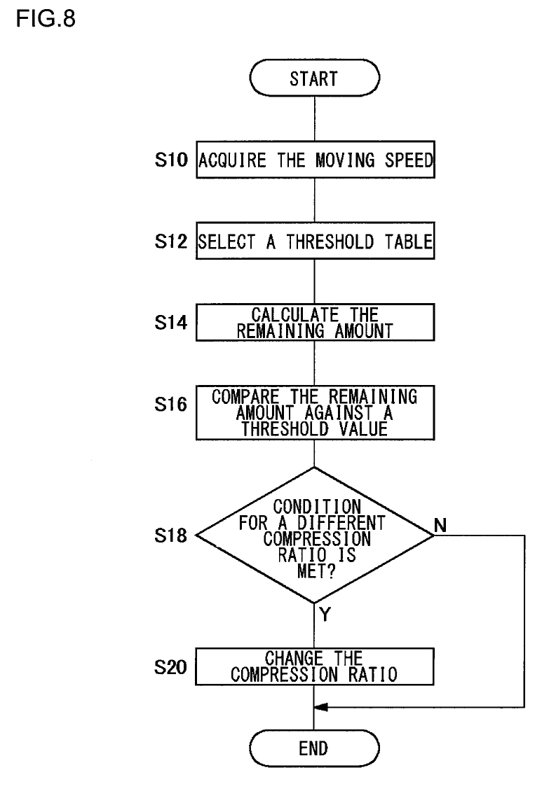

An operation of the image communication system 200 structured as above will now be explained. FIG. 8 is a flowchart showing a procedure for changing the compression ratio in the image transmitting apparatus 202. The acquiring unit 230 acquires the moving speed (S10). The selector 234 selects a threshold table 250 (S12). The calculation unit 236 calculates the remaining amount of coded data (S14). The decision unit 238 compares the remaining amount thereof with threshold values (S16). If a condition for a compression ratio that is different from the compression ratio in current use is met (Y of S18), the decision unit 238 will change the compression ratio (S20). If, on the other hand, a condition for a compression ratio that is different from the compression ratio in current use is not met (N of S18), step S20 will be skipped.

By employing the present embodiment, the compression ratio is changed based on the transmission status of coded data and the data amount of coded data generated, so that a compression ratio suitable for the current transmission status can be set. Also, since the compression ratio suitable for the current transmission status is set, the reproduction quality of the moving images can be improved and the moving images can be reproduced smoothly. Also, since the compression ratio is changed by constantly reflecting the moving speed, the compression ratio in response to a change in the environment can be set. Also, the compression ratio is set such that it is less likely to be changed as the moving speed increases, so that the frequent changes of compression ratio can be avoided. Also, once a table is selected according to the moving speed, the same processing will be performed thereafter, so that the processing can be made simpler.

### Third Embodiment

Similar to the above-described embodiments, a third embodiment of the present invention relates to an image communication system for transmitting the moving images via a radio communication network. The image transmitting apparatus according to the third embodiment also controls the code rate by constantly reflecting the moving speed, based on the remaining amount of coded data in the transmit buffer. When deriving the remaining amount thereof, the image transmitting apparatus uses the amount of coded data in parallel. To reduce the adverse effect caused by an instantaneous variation, the image transmitting apparatus averages the data amount of coded data over a predetermined period of time. Here, the image transmitting apparatus adjusts the period of time for the averaging so that it can be related to the moving speed. For example, the higher the moving speed is, the averaging period of time will be set longer. Similar to the second embodiment, this is equivalent to a control performed such that the compression ratio is less likely to be changed as the moving speed increases.

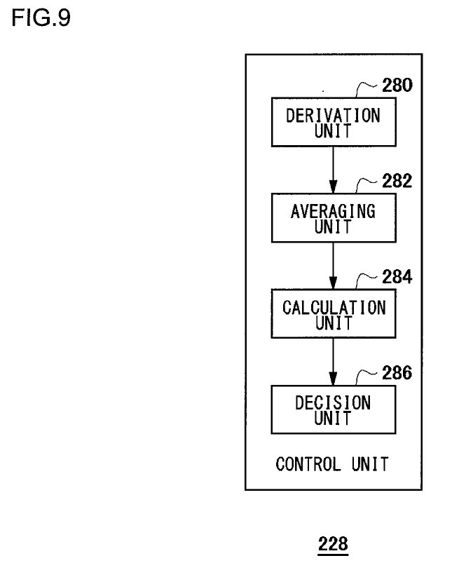

An image communication system 200 according to the third embodiment is similar to that shown in FIG. 3. An image transmitting apparatus 202 according to the third embodiment is similar to that shown in FIG. 4. An image receiving apparatus 204 according to the third embodiment is similar to that shown in FIG. 7. A description is given here centering around features different from those in the previous embodiments. FIG. 9 illustrates a structure of a control unit 228 according to the third embodiment of the present invention. The control unit 228 includes a derivation unit 280, an averaging unit 282, a calculation unit 284, and a decision unit 286.

The derivation unit 280 receives the moving speed from the not-shown acquiring unit 230. The derivation unit 280 derives the processing period, based on the moving speed. For example, the derivation unit 280 stores beforehand the processing periods in such a manner that they are associated respectively with a plurality of moving speeds, and selects a processing period associated with a moving speed closest to the received moving speed. The derivation unit 280 defines the processing periods in such a manner that a processing period corresponding to a higher moving speed is set to a longer period. The derivation unit 280 outputs the processing period to the averaging unit 282.

The averaging unit 282 receives the processing periods from the derivation unit 280, and also receives the data amount of coded data from the not-shown packetization processing unit 224. The averaging unit 282 calculates an average value of the data amount over a processing period. A moving average is calculated as the average, for instance. The averaging unit 282 outputs the average value to the calculation unit 284. The calculation unit 284 receives the average value from the averaging unit 282, and also receives the transmission rate from the not-shown communication unit 226. The calculation unit 284 calculates the remaining amount of coded data, based on the average value and the transmission rate. The calculation of the remaining amount thereof may be done in a similar manner analogous to what is done by the calculation unit 236 described in conjunction with FIG. 4 and therefore the description thereof is omitted here. The calculation unit 284 outputs the remaining amount of coded data to the decision unit 286. The decision unit 286 receives the remaining amount of coded data from the calculation unit 284, and determines the compression ratio, based on the remaining amount thereof. The decision unit 286 performs the same processing as that performed by the decision unit 238 of FIG. 4 and therefore the description of the processing is omitted here. Note that a single kind of table 250 may be stored in the not-shown storage 232.

By employing the present embodiment, the period for the averaging is adjusted by constantly reflecting the moving speed, so that the compression ratio in response to a change in the environment can be set. Also, since a single kind of table suffices, the storage memory capacity can be reduced. Also, the compression ratio is set such that it is less likely to be changed as the moving speed increases, so that the frequent changes of compression ratio can be avoided.

The description of the invention given above is based upon illustrative embodiments. The present invention is thus not limited to the structures and components of the embodiments and are within the applicable range of the present invention defined by WHAT IS CLAIMED. Also, various modifications could be developed if the functions deriving from the structure and components of the above-described embodiments are achievable.

The motion MPEG scheme is used, in the first to third embodiments of the present invention, as a method for compressing and coding the data. However, this should not be considered as limiting and, other compressing/coding methods, such as motion JPEG2000 scheme, MPEG (Moving Picture Experts Group) scheme, H.264 method or VC-1 method, may be used. Also, WiMAX (Worldwide Interoperability for Microwave Access) may be used as the radio communication network.

In the first to third embodiments of the present invention, the data amount of coded data is outputted in units of frame, and the compression ratio is controlled in units of frame as well. However, this should not be considered as limiting and these processings may be done in units of macroblock. In such a case, the transmission interval between packet signals may be used for the control of the compression ratio. For example, the table 250 is defined in such a manner that a higher compression ratio is selected for a shorter transmission interval. According to this modification, the compression ratio can be controlled at fine intervals between the respective timings.

In the first to third embodiments of the present invention, the transmission rate is used to determine the compression ratio. However, this should not be considered as limiting and, for example, parameters, related to communications, other than the transmission rate may be used. As an example, the number of retransmissions is used, and the case where the number of retransmissions is large is equivalent to the case where the transmission rate is low. According to this modification, various types of parameters can be used to control the compression ratio.

### INDUSTRIAL APPLICABILITY

The present invention verifies whether the coded frame has been transmitted within a frame period or not, so as to set the compression ratio in the compressing and coding of the data. Thus, the amount of data to be transmitted can be adjusted according to a propagation environment and therefore the transmission of the moving images with high real-timeliness can be achieved.

1. An image transmitting apparatus, comprising:
a compressing-coding unit configured to generate coded data by compressing and coding moving image data;
a transmitter configured to transmit the coded data generated by said compressing-coding unit;
an acquiring unit configured to acquire the moving speed of an object;
a control unit configured to set the compression ratio with which to compress and code the moving image data in said compressing-coding unit, based on the moving speed acquired by said acquiring unit, a transmission status of the coded data in said transmitter and a data amount of the coded data generated by said compressing-coding unit.

2. An image transmitting apparatus according to claim 1, wherein a change in compression ratio is reduced as the moving speed acquired by said acquiring unit becomes high.

3. An image transmitting apparatus according to claim 1, said control unit including:
a selector configured to store beforehand a plurality of kinds of threshold values and select any one from among the plurality of kinds of threshold values;
a calculation unit configured to calculate the remaining amount of coded data, based on the transmission status of the coded data in said transmitter and the data amount of the coded data generated by said compressing-coding unit; and
a decision unit configured to determine the compression ratio based on the remaining amount calculated by said calculation unit and a threshold value selected by said selector.

4. An image transmitting apparatus according to claim 1, said control unit including:
a derivation unit configured to derive a processing period, based on the moving speed acquired by said acquiring unit;
an averaging unit configured to average a data amount of the coded data generated by said compressing-coding unit, over the processing period derived by the derivation unit;
a calculation unit configured to calculate the remaining amount of coded data, based on the transmission status of the coded data in said transmitter and the data amount average by said averaging unit; and
a decision unit configured to determine the compression ratio based on the remaining amount calculated by said calculation unit and a threshold value selected by said selector.

5. An image transmitting method, comprising:
generating coded data by compressing and coding moving image data;
transmitting the generated coded data;
acquiring the moving speed of an object; and
setting the compression ratio of compressing and coding, based on the moving speed, a transmission status of coded data and a data amount of the generated coded data.

6. An image transmitting method, comprising:
a compressing-coding unit configured to compress and code moving image data for each frame;
a transmitter configured to transmit coded data compressed and coded by said compressing-coding unit; and
a control unit configured to set the compression ratio of the compressing and coding, based on a transmission status of the coded data within each frame period and a data amount of the coded data.
